(19) United States
(12) Patent Application Publication
(10) Pub. No.: US 2009/0137227 A1
(43) Pub. Date: May 28, 2009

(54) Federated Virtual Network of Communications Services

(75) Inventor: Ahmed Bencheikh, Fairfax Station, VA (US)

Correspondence Address: FENWICK & WEST LLP, SILICON VALLEY CENTER, 801 CALIFORNIA STREET, MOUNTAIN VIEW, CA, 94041, US

(73) Assignee: 4DK TECHNOLOGIES, INC., Herndon, VA (US)

(21) Appl. No.: 11/944,860

(22) Filed: Nov. 26, 2007

(51) Int. Cl. H04M 1/66

(52) U.S. Cl. 455/411

(57) ABSTRACT

A federated virtual network enables the creation of a logical network from multiple physical communications networks that each provide one or more communications services. The communications networks register their service capabilities with a network resources register. Users may then request from their networks a particular type, capability, and/or capacity of a network service using their communication devices. If the service requests are authorized, the network resources register maps the requestor's communication device to one or more network services offered by another network. Verifying the authorization may be performed by consulting an independent entity, which thus acts as a gatekeeper for the services. In this way, communications networks can expand their services and coverage by dynamically tapping into other networks' assets, on the fly and on an ad hoc basis (e.g., in case of emergencies, traffic peaks, or whenever additional services are needed).

### BACKGROUND

This invention relates generally to wireless communications systems, and in particular to providing access to wireless services from multiple communications networks.

In a wireless communication system, the Home Subscriber Sever (HSS) or Home Location Register (HLR) is the main database of permanent and semi-permanent subscriber information for a particular mobile network. The HLR is an integral component of CDMA (code division multiple access), TDMA (time division multiple access), and GSM (Global System for Mobile communications) networks, and the HSS is an integral component of the IMS (IP Multi-media Subsystem) architecture. Maintained by each subscriber's home carrier, the HLR and HSS contain pertinent user information, including user identification, subscription information, account status, and preferences for each subscriber features and services. Data stored in an HLR/HSS may include, without limitation, user ID, services to which the subscriber has subscribed, settings to allow the subscriber to access those services, the current location of the subscriber, and call divert settings. The HLR/HSS can be viewed as a single logical master database that can be implemented as separate physical databases when the data to be stored is more than the capacity of a single unit (e.g., an SD-HLR for a Super Distributed HLR).

The HLR/HSS interacts with a Mobile Switching Center (MSC), a softswitch or an S-CSCF, which is a used for call control and processing and serves as a point-of-access to the Public Switched Telephone Network (PSTN), the fixed telephone network. A Visiting Location Register (VLR) maintains temporary user information (such as current location), which allows the network to manage requests from roaming subscribers who are out of the area that is covered by their home system. When a MSC, for example, detects a new mobile station associated with a subscriber who does not belong to its network (i.e., a roaming subscriber), the MSC updates the VLR of its network and updates the HLR of the subscriber's home network so that the subscriber's HLR will know the location of the subscriber.

It would be desirable to create a virtual network that uses the services and assets of multiple physical communications networks. However, because a traditional HLR or HSS does not provide or contain any information on the network resources offered by its network, nor does it allow for exposing and sharing of the capabilities and services offered by its network, current wireless networking technology cannot share and allocate resources in an intelligent way.

### SUMMARY

A federated virtual network enables dynamic creation of a logical network from multiple physical communications networks that each provide one or more communications services. Each of the communications networks register their service capabilities with a Network Resources Register (NRR). Users may then request a particular type, capability, and/or capacity of network service using their communication devices. The NRR receives these requests, verifies each requestor's authorization for the requested service, capability, or capacity, and maps the requestor's communication device to one or more network services. In this way, a set of participating networks can be turned into communication assets that can be leveraged as needed and based on the capabilities and services required by users. The services and capacity offered by the virtual federated network may thus be the sum of those offered to the virtual network by each of the networks, where access to those services is authorized according to centrally maintained policies.

In one embodiment of the invention, the authorization for a user to access requested network services is performed by consulting an independent entity (e.g., an authentication server), which thereby acts as a gatekeeper for the services. Embodiments of the invention may also allow users to access services offered by networks other than their home network, while preserving control over authentication and authorization to use them. In one embodiment of the invention, services and networks can be dynamically added to and/or removed from the virtual network during operation thereof.

Various applications exist for different embodiments of the invention. For example, one embodiment of the federated network is applied to facilitate a public safety system, where the federated network allocates and controls network services for public safety workers in response to an emergency. Using this embodiment, the first responders to an emergency can obtain the type and level of network resources they need to perform their jobs from multitude of participating networks each of which may be owned by commercial operators or public entities. A variety of other applications exist for embodiments of the federated virtual network described herein.

### BRIEF DESCRIPTION OF THE DRAWINGS

FIG. 1 is a network architecture diagram of a federated virtual network for communications services, in accordance with an embodiment of the invention.

FIG. 2 is a schematic diagram of a Network Resources Register for a federated virtual network, in accordance with an embodiment of the invention.

FIG. 3 is an interaction diagram of a process for providing network services to a subscriber via a federated virtual network, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

In accordance with embodiments of the invention, a federated virtual network leverages the services, capabilities, and assets of multiple participating communications networks. The federated virtual network is created from a number of services offered by the multiple different communications networks. Subscribers can then access these communications services, where access to the services by each subscriber can be managed by a central authority and/or by each of the participating networks that provide those services.

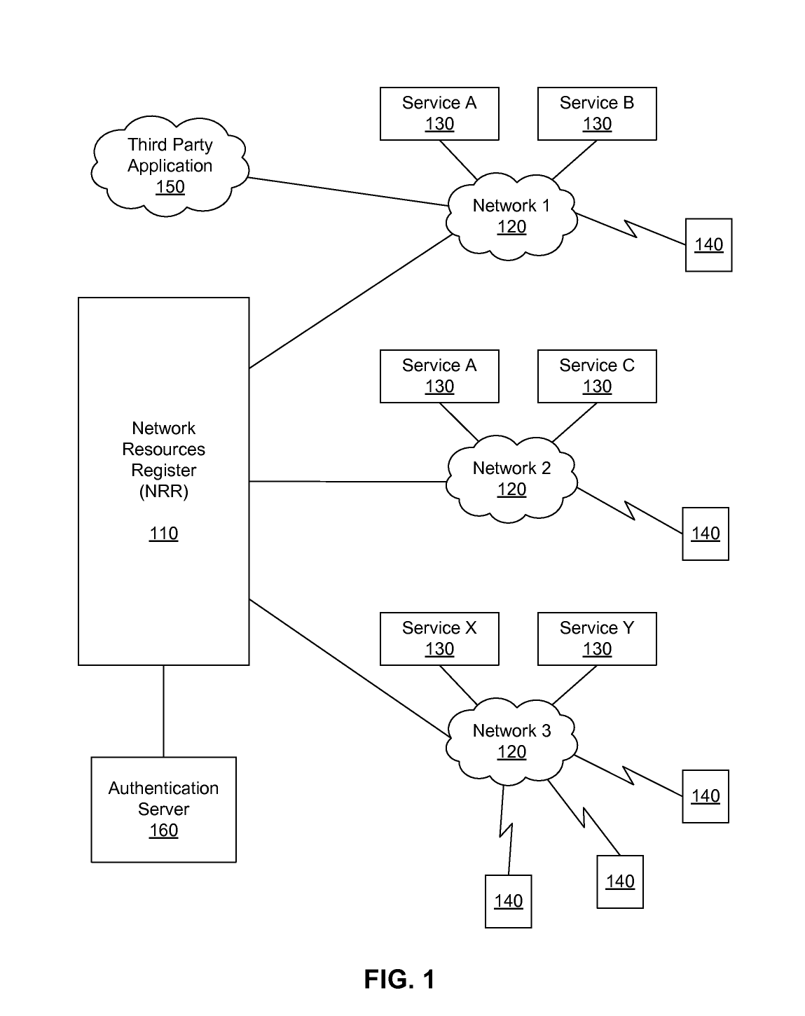

As illustrated in FIG. 1, a network architecture for a federated virtual network includes a number of communications networks 120. Each communications network 120 comprises hardware and/or software elements that implement a network of communications links, along with their associated intelligence or logic, arranged so that messages may be passed from one part of the network to another over the multiple links. The communications networks 120 may also be associated with one or more communications services 130, where the network 120 includes communications links and intelligence that enable communications with the service 130. It can be appreciated that the number of networks 120 and services 130 in each in this description are provided for explanation purposes only, and any number and combination of networks 120 and corresponding services 130 may exist.

A communications service 130 may be implemented with a network application, which may comprise code, logic, and combinations thereof, and may reside on one or more systems in a communications network infrastructure. A network application performs communications functionalities that implement a service on a communications network. Examples of network services include voice services (e.g., cellular, VoIP, PTT, and other voice services), messaging services (such as email, SMS, MMS, IM, voicemail, and other asynchronous communications services), and data services (e.g., weather, mapping, and other information retrieval services).

The communications network 120 can be accessed by a subscriber using a subscriber device 140. Each subscriber device 140 may comprise hardware and/or software elements that can be used to execute a specific function or set of functions to provide a subscriber with access to a network service 130. Examples of subscriber devices 140 include, without limitation, cellular phones, smart phones, personal digital assistants (PDAs), personal computers, and any other computing devices, mobile or stationary, that are designed to communicate via a communications network 120. The subscriber devices 140 may belong to a particular communications network 120, which provides its subscriber devices 140 with access to a number of communications services 130. For example, in FIG. 1, a subscriber may be a customer of a company that operates Network 1, so the subscriber's device 140 physically connects to Network 1 to obtain access to any communications services 123.

In addition, a subscriber may access communications services provides by a third party application 150, which can be accessed by the subscribers via any of the networks 120. In this example, the third party application 150 is provided by an entity that does not own the access network 120 used to access the third party application 150. Examples of third party applications 150 include mapping applications and Internet search applications that subscribers may access and use from their subscriber devices 140.

The federated virtual network further includes a network resources register (NRR) 110. The NRR 110 combines the communications services 130 offered by the multiple communications networks 120 into a single federated virtual network. In this sense, the NRR 110 performs several functions, including receiving requests for services from various participating networks, determining the availability of the requested services, determining a network's or an individual subscriber's authorization to access the requested services, and fulfilling requests for the services. So that it can manage and provide the access to the various communications services 130 in the virtual network, the NRR 110 maintains information about the service capabilities of each of the communications networks 120. Service capabilities describe the available communication assets and supported capabilities for a communications network 120. For example, the service capabilities for a particular communications network 120 may comprise, without limitation, services such as high performance Push-To-Talk, broadcast-multicast services, mobile television, high-speed data with highly secure encryption, and any of a variety of network service capabilities. Moreover, some of the information about network service capabilities may be static in nature and some may be dynamic. The available capacity/resources on a given network, for example, may be dynamic data that can be updated using a publish/subscribe model.

To enable the virtual network to regulate access to the virtual network by each of the subscriber devices 140, it may maintain a set of policies that describe the circumstances and limitations applicable to providing subscribers with access to the communications services 130 in the virtual network. These policies may be maintained by the NRR 110 or by the networks 120 themselves, the latter option generally allowing for better scalability. In one embodiment in which the networks 120 regulate access to services 130 by their subscribers, each network 120 authenticated and authorizes its primary home subscribers. A defined relationship governed by an agreed upon policy between the participating networks 120 can then be enforced by the NRR 1 10. These rules and policies enforced by the NRR 110 may be defined by the participating networks 120, and different networks 120 may use different authentication and authorization rules. Information about the subscribers may eventually be passed to the NRR 110 along with the request for services from each subscriber's home network 120. The NRR 110, or a third party acting on behalf of the NRR 110, may thus act as a mediation system between or among the communications networks 120.

The communications networks 120 may be of different types, such as GSM and CDMA networks. To allow for communication and exchange of information between two or more communications networks 120 of a different nature, the NRR 110 may use a “Protocol Converter” and a “Data Schema Adapter” functionalities. These functionalities may be provided by a Service Control Point (SCP) or can be made part of the logic of the NRR 110 itself. Alternatively, or in addition, embodiments of the system may use network enabling technologies such as those described in U.S. application Ser. No. 11/739,023, filed Apr. 23, 2007, and/or U.S. application Ser. No. 11/676,400, filed Feb. 19, 2007, both of which are incorporated by reference herein.

The NRR 110 can perform the authentication itself to determine whether a particular subscriber can access a requested service 130, or the NRR 110 can consult an external source for this authentication. In one embodiment, the NRR 110 is configured to consult an authentication server 160. The authentication server 160 may be operated by a separate entity and located remote from the NRR 110. In this way, a communications company can operate the virtual network, while a customer or public agency can regulate access to the network merely by maintaining a database at the authentication server 160. The connection between the NRR 110 and the authentication server 160 is a logical connection, and a real physical connection may be made via an operator network or a private network.

In this way, the NRR 110 serves as a central management unit for all of the communications services 130 offered by a number of communications networks 120. The NRR 110 can thus consolidate network resources and offer them in an organized and consistent fashion, according to predetermined policies and rules. In cases where two or more networks 120 provide the same or substantially equivalent service 130, the choice of which network 120 to use when fulfilling a request for services could be based on rules and policies defined by the network operators and enforced by the NRR 110. Subscribers are thus not constrained to use only those services 130 offered by a particular network 120, but rather can access all of the services 130 for which they are authorized across the multiple networks 120.

In one example, a subscriber of Network 1 may obtain access to Service C on Network 2 through the subscriber's own Network 1 access. When the subscriber requests the Service C, which is not provided by Network 1, Network 1 interrogates the NRR 110 to discover whether there exists a network that does provide Service C. The NRR 110 performs any necessary authentication to decide whether the subscriber from Network 1 may access Service C from Network 2. This is done, in one embodiment, by the NRR 110 checking if there is a relationship established between Network 1 and Network 2 that can provide Service C. If so, the NRR 110 then maps the subscriber's connection on Network 1 to Service C on Network 2. The actual connectivity between Network 1 and Network 2 that provides Service C may be established by the two networks on a need-by-need basis.

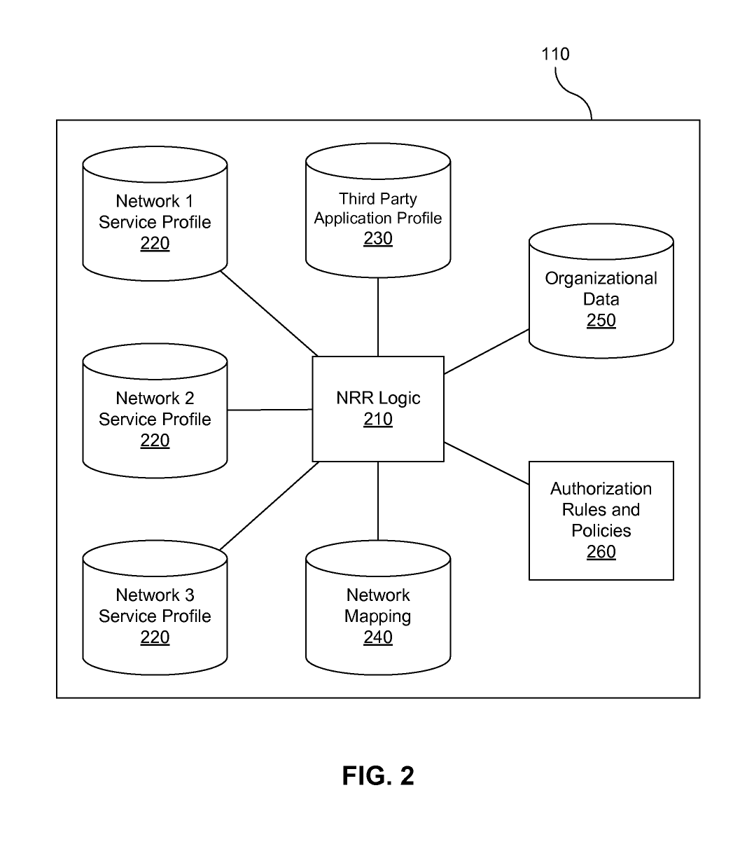

FIG. 2 illustrates an embodiment of an NRR 110 for use in the system of FIG. 1, showing the information that the NRR 110 maintains to enable it to perform its functionalities. The NRR 110 comprises logic 210, which may be implemented in hardware, software, or any combination thereof. The NRR logic 210 performs the functionalities of the NRR 110, including connectivity, routing, session management, mobility management, protocol conversions, and any other functions needed or desired for the NRR 110. The NRR logic 210 is communicatively coupled to the data and other resources maintained by or in connections with the NRR 110, as described below. In other embodiments, these resources and data used by the NRR 110 may be maintained off the NRR 110 in a network drive or other remote storage.

The NRR 110 comprises a number of network service profiles 220, each of which tracks information corresponding to a communications network 120 associated with the NRR 110. In one embodiment, a network service profile 220 contains a description of the services 130 that are provided by a particular network 130 and available to the federated network. This information may be obtained from a network operator, who may provision the services that the operator wants to make available to the federated network by including a description of the services in the network services profile 220. In one embodiment, each service 130 has a unique service identifier, where the service identifiers are mapped to a network identifier associated with their networks 120. (If services identifiers are not unique across networks, the identifier used by the NRR 110 may still be unique, e.g., using a simple service identifier format that comprises NetID_ServiceID, where NetID is unique to each participating network.) A service 130 in the network services profile 220 may thus be described by its corresponding service identifier, network identifier, a description of the service, and any rules and policies for access to that service. This information may be stored for each service 130 of a network 120 in a database of profiles 220, as shown, in a single consolidated database, or in any other arrangement as desired.

In addition to keeping track of the available services 130 by the network services profiles 220, the NRR 110 may also maintain information about one or more available third party applications 150. In one embodiment, the NRR 110 maintains this information in a third party application profile 230. The application profile 230 may contain information about one or more third party applications 150, similar to the information maintained by each network service profile 220 for the a communication service 130 on a particular network 120. The operator of the NRR 110 may receive this information from a provider of the third party application 150, the operator may provision this information itself, or the information may be discovered and subscribed to automatically.

The NRR 110 may further maintain a database of organizational data 250, or have access to the database 250 maintained by a third party. The database of organizational data 250 stores information about at least some of the subscribers who are associated with a particular organization but may belong to different ones of the communications networks 120. For example, the organization may be a company or a public agency, or a collection thereof (e.g., a set of agencies that provide public services). The NRR 110 may be configured to apply specific rules or policies that use information about the subscribers in the organization, such as roles and priorities to regulate access to the federated virtual network services. These rules or policies may also be stored in the organizational data 250, which thus enables the NRR 110 to access it and apply any applicable rules or policies based on the data.

The NRR 110 may further include authorization rules and policies 260 that describe how networks and/or subscribers may access and use the consolidated services 130 offered by the communications networks 120. These rules and policies 260 defined in the NRR 110 may describe, among other things, the relationship between the participating networks 130 and services providers, including rules for how to determine whether certain subscribers are allowed access to which services 130, and the quality or extent to which that access can be granted. The rules and policies 260 stored in the NRR 110 are applied to the services 130 offered via the federated virtual network, and the participating networks 120 may use different rules and policies for authentication, authorization, and policy enforcement within their own services layer or network 120.

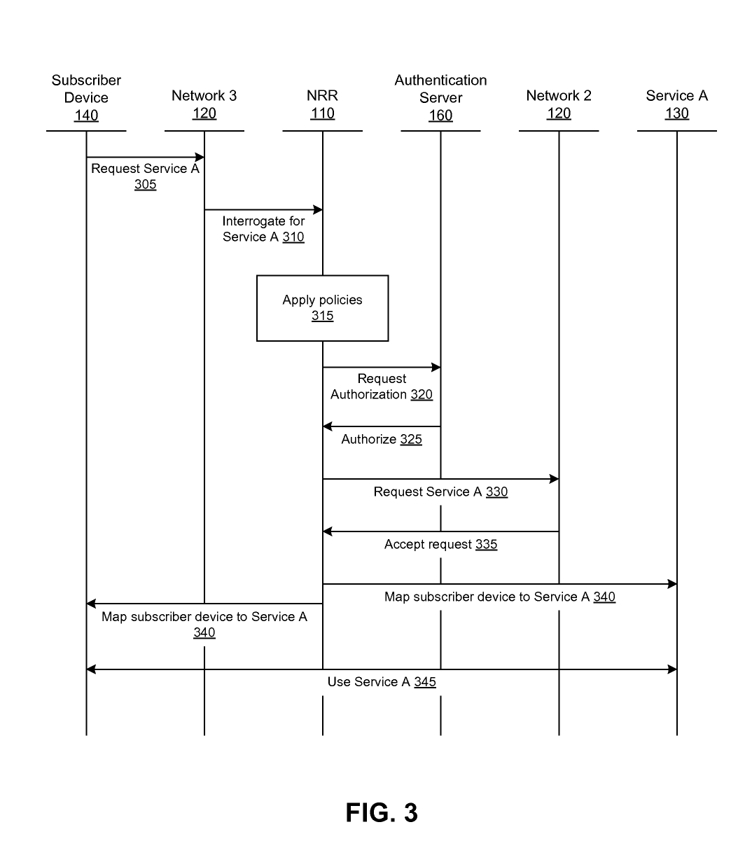

FIG. 3 illustrates the operation of the federated virtual network, in accordance with one embodiment of the invention. In this example, with reference to the system in FIG. 1, a subscriber of a communications network 120, Network 3, uses a subscriber device 140 to obtain access to a communications Service, Service A, which is not on the subscriber's own communications network 120.

In a first step, the subscriber device 140 requests 305 Service A from the subscriber's own network 120, which is Network 3 in this example. This request may be for a new type of network service or for new or expanded capabilities and/or capacity of an existing type of network service. If the requested service 130 were available on the subscriber's own network 120 and the user is allowed access to it, the network 120 could simply provide the subscriber with this service 130. But in this example, the requested Service A is not provided by Network 3, so the subscriber will have to obtain access to Service A via the federated virtual network. Since Service A is not available on Network 3, the Network 3 interrogates 310 the NRR 110 to find out which other participating network 120 can provide that particular service to that particular user. The network identifier of the access network, Network 3, as well a subscriber identifier may be sent with this interrogation request.

Upon receiving the request, the NRR 110 applies 315 any applicable rules or policies to determine whether and/or to what extent the requesting network and/or subscriber should be granted access to the requested service 130. The NRR 110 then reviews the information stored in its network service profiles 220 to determine which participating networks 120 provide the requested service. As in this example, where both Networks 1 and 2 offer Service A (shown in FIG. 1), multiple communications networks 120 may offer the requested service 130. In such a case, the policies applied 315 by the NRR 110 may help to select which communications network 120 to choose for providing the requesting subscriber with the service 130. In this example, the NRR 110 selects Network 2 to provide Service A to the subscriber.

Before completing the request, the NRR may request 320 authorization from the authentication server 160 to provide Service A to the subscriber. As described above, the federated network may be regulated to provide different services and/or different levels of services to different subscribers, who may belong to an organization or other group of subscribers. The NRR 110 thus obtains authorization from the authentication server 160 to carry out this scheme. If the subscriber is authorized to have the requested service 130, the authentication server 160 authorizes 325 the NRR 110 to provide the service 130 to the subscriber. This authorization may also include a specification of the level and duration of the service 130 that the subscriber is allowed to access.

The NRR 110 then requests 330 Service A from Network 2. This request may state that a subscriber on Network 3 wants access to Service A on Network 2, and it may further specify the requirements for the execution of the service (e.g., necessary bandwidth, quality of service, and any other relevant parameters). Network 2 then accepts 335 the request if it is able to fulfill it. The NRR 110 then facilitates the connection by mapping 340 the subscriber device 140 on Network 3 to Service A on Network 2. In one embodiment, the NRR 110 intervenes only in the signaling path; the media and other data provided by the service flows directly between Networks 2 and 3 during use 345 of Service A by the subscriber device 140. The NRR 110 may maintain the mappings between the operator network identifiers during the service session.

In one embodiment, the process for obtaining access to a particular type, capability, and/or level of network service may be transparent to the subscriber and subscriber device 140. For example, if a subscriber requests a service, the subscriber's network 120 may check if it can provide that service, and if not the network 120 may send a request to the NRR 110 to look for an alternative network 120 that can provide the requested service. The subscriber may be notified at that point by an accept or reject message sent back to the subscriber device 140, allowing the subscriber to accept or deny the service from the other network 120. Alternatively, the subscriber's home network may have a trusted relationship with other participating networks. In such a case, the user may not need to be authenticated, since the system can trust the fact that the subscriber's home network would have done so. In this way, the service is directly provided to the subscriber upon the subscriber's request.

In one embodiment, the federated virtual network implements a public safety network, which uses network resources from a number of different communications networks 120. In this way, public safety agencies act as special service providers with their own communications and services assets that may be accessible from any of the participating networks 120. The subscribers are members of one or more public service agencies involved with the network. The authentication server 160 may thus be operated by a public service agency, which can thus control and regulate the access to the network resources given to each public safety subscriber. The public safety organizational data 250 may be provided directly from or through the NRR 110 so that the appropriate policies can be enforced when a particular public safety subscriber accesses a given service 130 of one of the participating networks 120.

The public safety agencies and the commercial operators may also provide access to each other's networks using the federated virtual network described herein. For example, a public safety user may have access to a commercial operator's network on-the-fly whenever needed, and the public safety agent will then be granted a high level of QoS and priority access. This high level of QoS and priority may be defined as part of the public safety agent's profile, since after the agent is authenticated as a public safety user the agent may be given a higher priority based on the defined policies.

In other applications, the federated network can be used to expand a coverage area or to provide a level of service that most efficiently meets a user's preferences. This is accomplished by sharing the communications services 130 of multiple overlapping communications networks 120. This may be useful, for example, if a public safety agency needs more capacity or needs to establish an ad hoc network on-the-fly that would look just like a private public safety network. An appropriate level of authentication and policies may be offered through the NRR 110 by the access network 120 being used. The access network 120 to be used may be selected based on set of criteria, among which may be the networks' capability of accommodating the needs and policies of the public safety users. This may be used, for example, in an emergency situation, where a public safety agency or agencies need to use network coverage from multiple networks in a secure fashion and with priority access in the incidental area and on the fly.

In one embodiment, embodiments of the virtual federated network may be used to provide services to roaming subscribers. Home subscribers are known to an access network 120 being used while roaming users are not. To provide services to a roaming subscriber, the access network 120 identifies the home network of the subscriber and sends a request for its authentication, authorization, and possibly profile transfer. This can be done through the NRR 110 or directly between the participating networks. If the two networks use different technologies, the NRR 110 may need to mediate between the two networks. With embodiments of the invention, roaming subscribers may thus be provided access to networks on-the-fly, where the selected network for service is chosen from among a set of networks that provide the requested service. The network on which the user is roaming may then be used just as a transport pipe, while the requested services come from a third party network with which the roaming partner has negotiated tariffs and terms to provide the requested service to its customers. The requested services may actually be provided by the subscriber's own home network.

In another embodiment, an MVNO may use the federated virtual network system architecture to select services from various networks 120 to provide to the MVNO's subscribers, without ever having to operate a communications network 120 itself.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. Any of the steps, operations, or processes described herein may be performed or implemented with one or more hardware or software modules, alone or in combination with other devices. A software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for providing access to communications services via a virtual network using multiple participating networks, the method comprising:
storing profiles for a plurality of participating networks, each profile specifying a set of services offered for allocation by the corresponding participating network;
receiving a request for a service from a first one of the participating networks, the request specifying at least one of a type, capability, and capacity of the requested service;
verifying the request for the service according to a set of policies;
selecting a second one of the participating networks to provide the requested service, the selecting based at least in part on the stored profiles; and
mapping the requested service from the selected second participating network to the requesting first participating network to satisfy the request.

2. The method of claim 1, wherein the request specifies a type of a service that is not offered by the first participating network.

3. The method of claim 1, wherein the request specifies a capability of a service that is not offered by the first participating network.

4. The method of claim 1, wherein the request specifies a capacity of a service that is not offered by the first participating network.

5. The method of claim 1, wherein the request specifies an additional capability or capacity of a service that is offered by the first participating network.

6. The method of claim 1, wherein verifying the request comprises requesting authorization from an independent server, and receiving response that indicates authorization.

7. The method of claim 1, wherein the first and second participating networks are operated by different network operators.

8. The method of claim 1, further comprising:
receiving a profile for an additional participating network, the profile specifying a set of services offered for allocation by the additional participating network;
receiving a second request for a service from a third one of the participating networks, the request specifying at least one of a type, capability, and capacity of the requested service; and
mapping the requested service of the second request from the additional participating network to the third participating network to satisfy the second request.

9. A method for providing access to communications services by a communications network for subscribers, the method comprising:
receiving at a first network a request for service from a subscriber device, the request specifying at least one of a type, capability, and capacity of the requested service;
authenticating the request using a set of rules that determine whether the subscriber device is allowed to access the requested service;
providing the request to a network resources register of a virtual communications network;
receiving from the network resources register a mapping to the requested service on a second network; and
connecting the subscriber device to the requested service on the second network.

10. The method of claim 9, wherein the request specifies at least one of a type, capability, or capacity of a service that is not offered by the first network.

11. The method of claim 9, wherein the request specifies an additional capability or capacity of a service that is offered by the first network.

12. The method of claim 9, wherein the first network is a home network for the subscriber device.

13. The method of claim 9, wherein the first and second networks are operated by different network operators.

14. The method of claim 9, further comprising:
publishing, to a network resources register, a profile for the first network, the profile specifying a set of services offered for allocation by the first network.

15. The method of claim 9, further comprising:
determining that the first network cannot provide the requested service to the subscriber device.

16. A federated network system for providing access to services from multiple communications networks, the network system comprising:
a plurality of participating networks, each participating network providing access to one or more services offered by the participating network;
a database storing a profile for each participating network, each profile specifying a set of services offered for allocation by the corresponding participating network; and
a network resources register coupled to the participating networks, the network resources register configured to:
receive requests from the participating networks for services, each request specifying at least one of a type, capability, and capacity of the requested service,
verifying the requests for the service according to a set of policies,
selecting participating networks to satisfy the requests for services, the selecting based at least in part on the stored profiles, and
mapping the services of the selected participating networks to the requesting participating networks to satisfy the requests.

17. The system of claim 16, wherein the network resources register is configured to receive requests that specify a type of a service that is not offered by the requesting participating network.

18. The system of claim 16, wherein the network resources register is configured to receive requests that specify a capability of a service that is not offered by the requesting participating network.

19. The system of claim 16, wherein the network resources register is configured to receive requests that specify a capacity of a service that is not offered by the requesting participating network.

20. The system of claim 16, wherein the network resources register is configured to receive requests that specify an additional capability or capacity of a service that is offered by the requesting participating network.

21. The system of claim 16, wherein the network resources register is configured to verify each request by communicating with an independent authentication server, the independent authentication server configured to provide authorization for the requests based on the set of policies.

22. The system of claim 16, wherein two or more of the participating networks are operated by different network operators.
